(19) United States
(12) Patent Application Publication
(10) Pub. No.: US 2025/0172832 A1
(43) Pub. Date: May 29, 2025

(54) VOA WITH DIGITAL CONTROL OF PHASE CHANGE MATERIAL

(71) Applicant: Cisco Technology, Inc., San Jose, CA (US)

(72) Inventors: Xunyuan ZHANG, Mechanicsburg, PA (US); Kadaba LAKSHMIKUMAR, Basking Ridge, NJ (US); Shiyi CHEN, Breinigsville, PA (US); Tao LING, Breinigsville, PA (US)

(21) Appl. No.: 18/523,328

(22) Filed: Nov. 29, 2023

(51) Int. Cl. G02F 1/035

(52) U.S. Cl. CPC G02F 1/035

(57) ABSTRACT

Embodiments herein describe a variable optical attenuator (VOA) with a waveguide that extends through one or more segments containing phase change material (PCM). A digital signal can change the state of the PCM in each of the segments from an amorphous state or a crystalline state. The PCM can be deposited on, or sufficiently near, the waveguide transmitting an optical signal. The PCM can change the refractive index of the waveguide, and hence, the extinction ratio so that the optical signal in the waveguide is attenuated. When in a transmission state, the PCM has little effect on the extinction ratio so that the optical signal travels through the waveguide substantially non-attenuated. However, when in an attenuation state, the PCM affects the extinction ratio of the waveguide so that the optical signal is attenuated.

### TECHNICAL FIELD

Embodiments presented in this disclosure generally relate to a variable optical attenuator (VOA) with phase change material that is digital controlled.

### BACKGROUND

Optical attenuators are devices for reducing the optical power of a light beam, for example a free-space laser beam or a telecom signal sent through an optical fiber/waveguide. VOAs have a degree of attenuation which is either manually adjustable or can be controlled with an electrical signal. Current VOA designs consume power during steady-state and when switching to different attenuation levels. These VOAs offer near noiseless attenuation of an optical signal, but consume substantial amounts of power (e.g., approximately 80 mW of continuous power dissipation for each lane). Moreover, VOAs often require calibration when being powered up in order to deliver the desired attenuation levels. Not only does calibration take time, but also calibration values have to be stored in non-volatile memory.

Also, current VOA designs can be quite large. For example, a VOA that offers 15 dB in attenuation at 0.5 dB steps can have dimensions of approximately 500 microns in length and 70 microns in width. Thus, VOAs can be a significant contributor to the size and hence the cost of a photonic chip.

### BRIEF DESCRIPTION OF THE DRAWINGS

So that the manner in which the above-recited features of the present disclosure can be understood in detail, a more particular description of the disclosure, briefly summarized above, may be had by reference to embodiments, some of which are illustrated in the appended drawings. It is to be noted, however, that the appended drawings illustrate typical embodiments and are therefore not to be considered limiting; other equally effective embodiments are contemplated.

FIG. 1A illustrates a VOA with segments containing phase change material, according to one embodiment.

FIG. 1B is a cross section of FIG. 1A, according to one embodiment.

FIG. 2 is a block diagram of a VOA with segments that provide different attenuation using phase change material, according to one embodiment.

FIG. 3A illustrates a VOA with segments containing phase change material, according to one embodiment.

FIGS. 3B and 3C are cross sectionals of the VOA in FIG. 3A, according to several embodiments.

FIG. 4 is a block diagram of a VOA with segments that provide different attenuation using phase change material, according to one embodiment.

FIG. 5 is a flowchart for operating a VOA with phase change material, according to one embodiment.

To facilitate understanding, identical reference numerals have been used, where possible, to designate identical elements that are common to the figures. It is contemplated that elements disclosed in one embodiment may be beneficially used in other embodiments without specific recitation.

### DESCRIPTION OF EXAMPLE EMBODIMENTS

### Overview

One embodiment presented in this disclosure is a VOA that includes an optical waveguide, phase change material (PCM) disposed on the optical waveguide, and electrodes configured to change a state of the PCM in order to change an attenuation of optical power in the optical waveguide.

Another embodiment presented in this disclosure is a VOA that includes an optical waveguide and a plurality of segments comprising material that is configured to switch between an attenuation state and a transmission state to change an attenuation of optical power in the optical waveguide. Moreover, the VOA does not consume power in order to maintain the material in the attenuation state or the transmission state.

Another embodiment presented in this disclosure is a method that includes receiving a desired attenuation for a VOA including PCM that changes an attenuation of optical power in an optical waveguide depending on a state of the PCM, changing the state of the PCM based on the desired attenuation, and transmitting an optical signal through the optical waveguide to achieve the desired attenuation.

### Example Embodiments

Embodiments herein describe a VOA with a waveguide that extends through a plurality of segments containing phase change material (PCM). A digital signal can change the state of the PCM in each of the plurality of segments from an amorphous state or a crystalline state. The PCM can be deposited on, or sufficiently near, the waveguide transmitting an optical signal. In one embodiment, when in the crystalline state, the PCM changes the refractive index, and hence, the extinction ratio so that the optical signal in the waveguide is attenuated. When in the amorphous state, the PCM has little effect on the extinction ratio so that the optical signal travels through the waveguide substantially non-attenuated.

The digital control signal can control the state of the PCM in the segment in the VOA to result in a desired, overall attenuation. As a simple example, a VOA may have a first segment that provides a 1 dB attenuation (when the PCM is in the crystalline state) and a second segment that provides a 0.5 dB attenuation. The digital signal can have one bit that controls the state of the PCM in the first segment and another bit that controls the state of the PCM in the second segment. When the PCM in the second segment is crystalline, but not the first segment, the overall attenuation of the optical signal when passing through both segments is 0.5 dB. When the PCM in the first segment is crystalline, but not the second segment, the overall attenuation of the optical signal when passing through both segments is 1 dB. When the PCM in both segments is crystalline, the overall attenuation of the optical signal is 1.5 dB. In this example, a two-bit digital control signal can be used to provide an optical attenuation of up to 1.5 dB in steps of 0.5 dB.

Some non-limiting advantages of a VOA that includes PCM is that the VOA consumes zero (or substantially no) power at steady-state. That is, after switching the PCM into the desired state, the PCM remains in that state without power (or voltage) being applied. This is unlike traditional VOAs that require continual power when in a non-switching, steady state. Moreover, a VOA with PCM does not require calibration, which means calibration does not have to be performed when the VOA is powered on, and memory is not needed in order to store calibration values. In addition, the VOAs described herein can be more compact (e.g., a length of 20 microns and a width of 10 microns). In multi-lane application, the total area savings from using the VOAs described herein can result in a large cost benefit when fabricating the photonic chip containing the VOAs.

In addition, it may be easier to realize a segmented structure in a VOA that relies on PCM to change the extinction ratio of the waveguide relative to prior VOA designs. This can be due to the smaller size or compactness of the VOAs described herein. Also, the VOAs can have faster settling times compared to current VOAs which operate in a thermal environment that relies on local heating to introduce a phase shift. Moreover, it can be easier to design automatic gain control (AGC) loops for the VOAs described herein since VOAs that rely on local heating have loop instabilities.

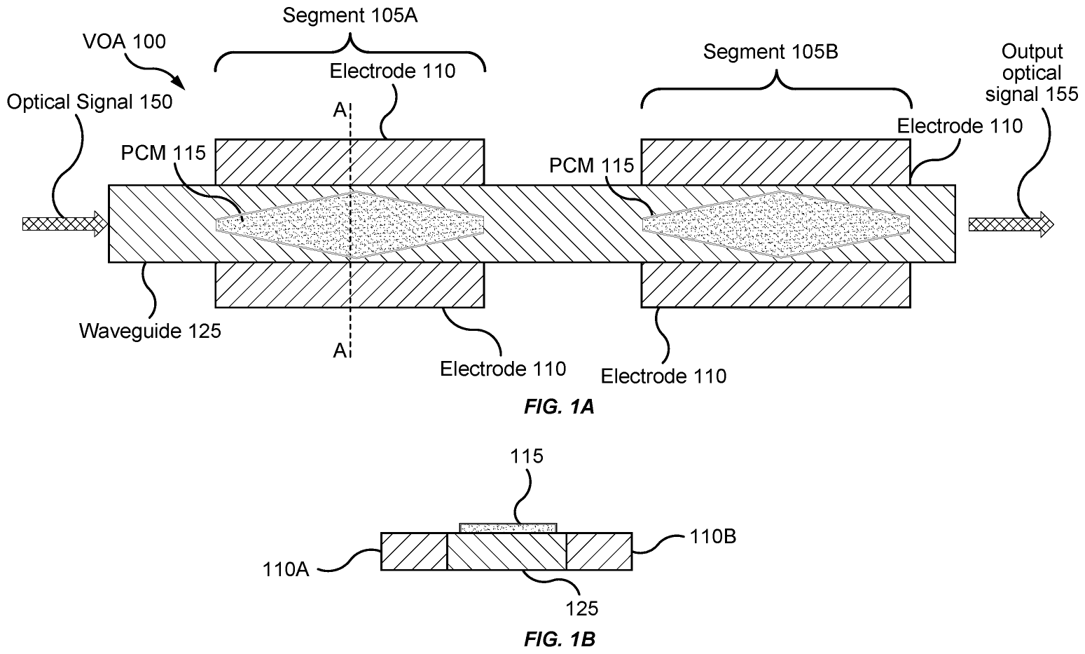

FIG. 1A illustrates a VOA 100 with segments 105 containing phase change material, according to one embodiment. FIG. 1A provides a top down view of the VOA 100.

In this example, the VOA 100 includes two segments 105A and 105B, but can have any number of segments. Each segment 105 includes PCM 115 which is designed or patterned to provide a desired attenuation in an optical signal 150 traveling through an optical waveguide 125. That is, the waveguide 125 receives the optical signal 150 which then travels through the segments 105.

In this example, the PCM 115 in each segment 105 is disposed on the waveguide 125. In one embodiment, the PCM 115 directly contacts the waveguide 125. However in other embodiments a thin layer of material may be disposed between the PCM 115 and the waveguide 125. In any case, the PCM 115 is disposed sufficiently close to the waveguide 125 so that the state of the PCM 115 can change the refractive index of the waveguide 125, and hence, the extinction ratio of the waveguide 125. The extinction ratio determines the amount of attenuation experienced by the optical signal 150 as it propagates through the segments 105.

As mentioned above, in one state, the PCM 115 has little to no effect on the optical signal 150. However, in the other state, the PCM 115 increases the extinction ratio so that the optical signal is attenuated when passing through the segment 105. Further, the size, shape, and thickness of the PCM 115 can determine the amount of attenuation each segment 105 applies on the optical signal 150. In one embodiment, the PCM 115 is designed so that each segment 105 provides a different attenuation on the optical signal 150. For example, the PCM 115 (when crystalline) in the segment 105A may provide a different attenuation than the PCM 115 in the segment 105B—e.g., the PCM 115 in the segments has a different size, shape, and/or thickness. Alternatively, the PCM 115 in the segments 105A and 105B may provide the same attenuation—e.g., the PCM 115 may have the same size, shape, and thickness.

While the examples below describe that when in a crystalline state the PCM 115 increases the extinction coefficient of the waveguide 125 but when in the amorphous state the PCM 115 does not substantially affect the extinction coefficient, for other PCMs it may be the opposite where in the crystalline state the PCM does not substantially affect the extinction coefficient but when in the amorphous state, the PCM does increase the extinction coefficient of the waveguide 125. The embodiments herein can be used with any type of PCM so long as in one state the PCM has little to no effect on the extinction of the waveguide 125, but in another state the PCM does affect the extinction. As such, a state of PCM that results in the segment attenuating the optical signal 150 is referred to herein as “the attenuation state” while a state of the PCM that results in little to no attenuation of the optical signal 150 is referred to as “the transmission state.”

In one embodiment, the PCM 115 is the same in each of the segments 105. However, in other embodiments, the segments 105 may have different types of PCM 115. Suitable PCM types include Germanium-antimony-tellurium (GST) or Ge—Sb—Se—Te (GSST) alloys. However, the embodiments herein are not limited to these types of PCM. That being said, GST and GSST may be more advantageous than other types of PCM since they are compatible with CMOS processes. Thus, the VOA 100 can be integrated into a CMOS process that may be used to fabricate other electrical and optical components on the same photonic chip or integrated circuit as the VOA 100.

The VOA 100 also includes electrodes 110 that control the state of the PCM 115. In this example, both segments 105 include a pair of electrodes 110. A control signal (which is discussed in more detail below) can independently set the state of the PCM 115 in each segment 105. That is, the PCM 115 in the two segments can have the same state, or opposite states.

The waveguide 125 outputs an output optical signal 155. If the PCM 115 in both segments 105 are both in the transmission state, then the output optical signal 155 is substantially the same as the optical signal 150 (although the segments 105 may provide a slight attenuation even when the PCM 115 is in the transmission state). If either (or both) of the segments 105 have PCM in the attenuation state, then the output optical signal 155 is attenuated relative to the optical signal 150.

FIG. 1B is a cross section of FIG. 1A, according to one embodiment. That is, FIG. 1B illustrates the cross section of the VOA 100 labeled A-A in FIG. 1A. FIG. 1B illustrates the waveguide 125 being flanked on both sides by electrodes 110A and 110B. The electrodes 110 may be a same material as the waveguide 125 or a different material. For example, the electrodes 110 and the waveguide 125 may both be silicon, although the electrodes 110 may be doped silicon while the waveguide 125 is intrinsic silicon. However, in other embodiments, the electrodes 110 and the waveguide 125 are different materials.

Further, FIG. 1B illustrates that the PCM 115 is disposed directly on a top surface of the waveguide 125. Changing the voltage on the electrodes 110 changes the state of the PCM 115. The voltages required to change the state of the PCM 115 can vary depending on the type of the PCM 115. The various voltages used to change different types of PCM are not described, but the embodiments herein can be used with any suitable type of PCM and control technique.

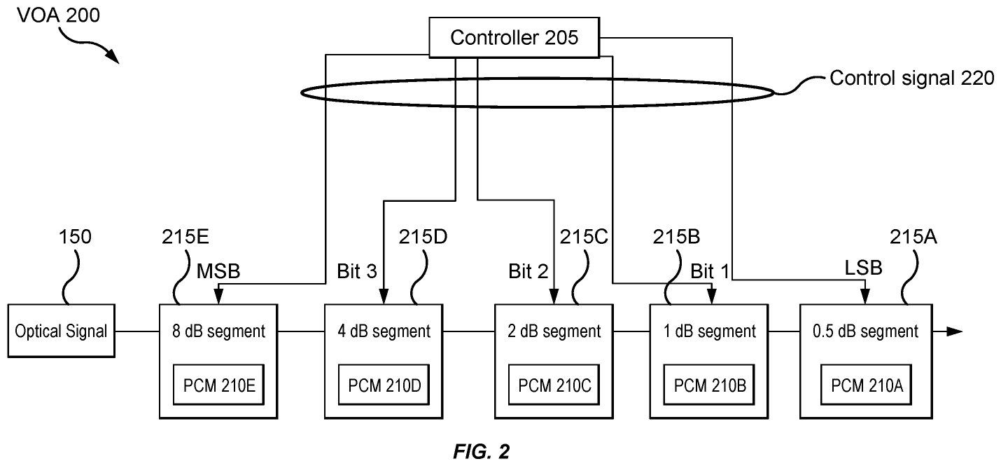

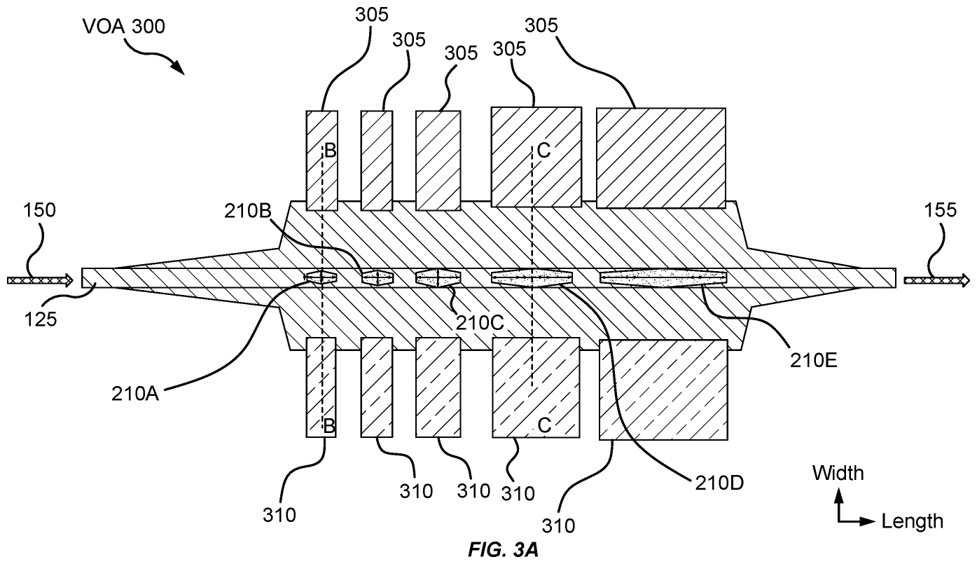

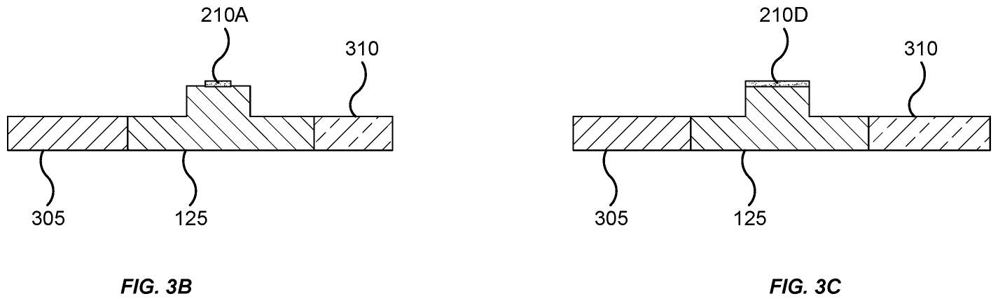

FIG. 2 is a block diagram of a VOA 200 with segments that provide different attenuation using PCM, according to one embodiment. The VOA 200 is a binary VOA since the attenuation provided by each segment doubles relative to the previous segment. That is, the segment 215A provides a 0.5 dB attenuation when its PCM 210A is in an attenuation state (e.g., a crystalline state). The neighboring segment 215B has PCM 210B that provides a 1 dB attenuation on the optical signal 150. The next segment 215C has PCM 210C that provides a 2 dB attenuation on the optical signal 150, and so forth. In this manner, each segment 215 provides an attenuation that is double relative to a neighboring segment 215 when the PCM 210 is in the attenuation state. This is achieved by altering the size, shape, thickness, and/or type of the PCM 210 in the segments 215. One embodiment of the VOA 200 is described in FIG. 3 below.

The VOA 200 also includes a controller 205 that provides a control signal 220 that sets the state of the PCM 210 in the segments 215. The controller 205 can be circuitry disposed on the same photonic chip or IC as the VOA 200, or may be an external controller disposed on a different IC. The controller 205 can include a processor (or processing element) and memory. The controller 205 can be hardware, firmware, software, or combinations thereof.

In this example, the control signal 220 includes five bits for controlling the state of the PCM 210 in the segments 215A-215E. That is, the least significant bit (LSB) controls the state of the PCM 210A in the segment 215A, Bit 1 controls the state of the PCM 210B in the segment 215B, Bit 2 controls the state of the PCM 210C in the segment 215C, Bit 3 controls the state of the PCM 210C in the segment 215C, Bit 4 controls the state of the PCM 210D in the segment 215D, and the most significant bit (MSB) controls the state of the PCM 210E in the segment 215E.

Programming the different PCM segments appropriately from the controller 205 can vary the attenuation of the VOA. For example, if the LSB has been programmed such that the PCM is in crystalline state, while the other segments are programmed to be in amorphous state, the optical signal is attenuated by 0.5 dB. In another example, assume Bit 1 is set to the value that sets, or keeps, the PCM 210B in the attenuation state while the other bits are set to a value that sets, or keeps, the PCM 210A, C-E in the transmission state. In that example, the optical signal 150 is attenuated by 1 dB after traversing the VOA 200. Thus, in this manner, the controller 205 can individually control the segments 215 so that only one segment attenuates the optical signal 150.

The controller 205 can also control the segments 215 so that multiple segments attenuate the optical signal 150. In that case, the overall attenuation of the optical signal 150 is the combination (or sum) of the attenuation provided by each segment 215 that has PCM 210 in the attenuation state. For example, assume the LSB and Bit 2 are set to the value that sets, or keeps, the PCM 210A and 210C in the attenuation state while the other bits are set to the value that sets, or keeps, the PCM 210B, 210D, and 210E in the transmission state. In that example, the optical signal 150 is attenuated by 2.5 dB after traversing the VOA 200. In another example, the controller 205 can set all the bits in the control signal 220 to the value that sets, or keeps, the PCM 210A-E to the attenuation state. In that case, the VOA 200 attenuates the optical signal 150 by 15.5 dB. Thus, the VOA 200 can be categorized as a 15.5 dB VOA which can attenuate an optical signal from 0 dB to 15.5 dB with a step size of 0.5 dB. That is, by setting the bits in the control signal 220, the controller can set the attenuation of the VOA 200 to 0.5 dB, 1 dB, 1.5 dB, 2 dB, 2.5 dB, 3 dB, 3.5 dB, etc. until reaching the maximum attenuation of 15.5 dB.

Of course, VOA 200 is just one example of a VOA. More binary attenuated segments could be added to the VOA (e.g., a 16 dB segment) or removed. In this manner, a plurality of segments can provide a different amount of binary optical attenuation.

FIG. 3A illustrates a VOA 300 with segments containing phase change material, according to one embodiment. The VOA 300 is one implementation of the VOA 200 in FIG. 2. That is, the VOA 300 is a binary VOA having five segments with PCM 210A-210E that can provide up to 15.5 dB of attenuation with a step size of 0.5 dB. Put differently, the PCM 210A provides 0.5 dB of attenuation when in the attenuation state, the PCM 210B provides 1 dB of attenuation when in the attenuation state, the PCM 210C provides 2 dB of attenuation when in the attenuation state, the PCM 210D provides 4 dB of attenuation when in the attenuation state, and the PCM 210E provides 8 dB of attenuation when in the attenuation state.

The PCM 210 in each segment is controlled by a respective pair of electrodes 305. The voltage on the electrodes 305 can be controlled based on the digital control signal 220 in FIG. 2. That is, the value of the digital control signal can set the voltage of the electrodes 305 so that they set the corresponding PCM 210 in the desired state. Advantageously, no voltage is needed at the electrodes 305 after the PCM 210 has been set to the desired state. Thus, in one embodiment, the VOA 200 does not consume power after the PCM 210 in each stage has been set to the desired state, unlike other VOAs that required power in order for them to provide the desired attenuation. That is, the VOA 200 does not consume power in order to maintain the PCM 210 in its current state.

Notably, the value of the voltages can be different when changing between the states—e.g., when moving from a crystalline state to an amorphous state versus moving from an amorphous state to a crystalline state. As mentioned above, the voltage used to change the state of different types of PCM can vary, and thus, is not described in detail herein. The VOA 200 can include additional logic or circuity (not shown) that can receive the digital control signals, and based on its value, drive voltages on the electrodes 305 to put the PCM 210 in the desired state.

The PCM 210A-E have different sizes which, at least partly, result in the different attenuations when in the attenuation state. In one implementation, the PCM 210A has a length of 0.62 microns. The narrowest width of the PCM 210A can be 0.1 microns while its widest width is 0.2 microns. As shown, the narrowest width of the PCM 210A is at the left and right ends where the PCM 210A expands to the greatest width at its middle before tapering to the ends.

The PCM 210B can also have a length of 0.62 microns. The narrowest width of the PCM 210B can be 0.1 microns while its widest width is 0.3 microns. As shown, the narrowest width of the PCM 210B is at the left and right ends where the PCM 210B expands to the greatest width at its middle and tapers to the ends.

In this example, the PCM 210C can have a length of 0.86 microns. The narrowest width of the PCM 210B can be 0.1 microns while its widest width is 0.45 microns. Like the PCM 210A and 210B, the narrowest width of the PCM 210C is at the left and right ends where the PCM 210C expands to the greatest width at its middle before tapering to the ends.

The PCM 210D can have a total length of 1.64 microns. Unlike PCM 210A-C, the PCM 210D expands from its left end until reaching its greatest width (e.g., 0.3 micron) and then has a constant width until again tapering to its ends. The region where the PCM 210D expands from 0.1 microns to 0.3 microns can have a length of 0.6 micron. The width of the PCM 210D can then be constant for 0.44 microns before the PCM 210D then tapers for the remaining 0.6 microns of its length.

The PCM 210E has a similar structure as PCM 210D but with different dimensions. For example, the PCM 210E can have a total length of 2.89 microns. The region where the PCM 210E expands from 0.1 microns to 0.3 microns (e.g., the maximum width) can have a length of 0.6 micron. The width of the PCM 210E can then be constant for 1.69 microns before the PCM 210D then tapers for the remaining 0.6 microns of its length.

These dimensions are just one example of dimensions for the PCM 210 that generate the desired binary attenuation in the segments of the VOA 200. Other dimensions and shapes may be used to achieve the same binary attenuation. Further, different types of PCM may have different dimensions and shapes.

FIGS. 3B and 3C are cross sectionals of the VOA in FIG. 3A, according to several embodiments. Specifically, FIG. 3B is a cross section of B-B in FIG. 3A. In one embodiment, the electrode 305 is formed by doping the semiconductor material forming the waveguide 125 (e.g., silicon) with a P-type dopant. However, in other embodiments, the electrode 305 may be a different material than the waveguide 125.

In one embodiment, the electrode 310 is formed by doping the semiconductor material forming the waveguide 125 (e.g., silicon) with an N-type dopant. However, in other embodiments, the electrode 310 may be a different material than the waveguide 125. Thus, in one embodiment, the electrodes 305 and 310 are doped using opposite type dopants.

The waveguide 125 has a ridge structure, on which the PCM 210A is disposed. While the embodiments describe using intrinsic (undoped) silicon as the waveguide 125, other suitable materials could be used, such as silicon nitride.

FIG. 3C is a cross section of C-C in FIG. 3A. In one embodiment, the electrode 305 is formed by doping the semiconductor material forming the waveguide 125 (e.g., silicon) P-type. However, in other embodiments, the electrode 305 may be a different material than the waveguide 125.

In one embodiment, the electrode 310 is formed by doping the semiconductor material forming the waveguide 125 (e.g., silicon) N-type. However, in other embodiments, the electrode 310 may be a different material than the waveguide 125.

The waveguide 125 has a ridge structure, on which the PCM 210D is disposed. Moreover, the width of the PCM 210D is larger than the width of the PCM 210A in FIG. 3B.

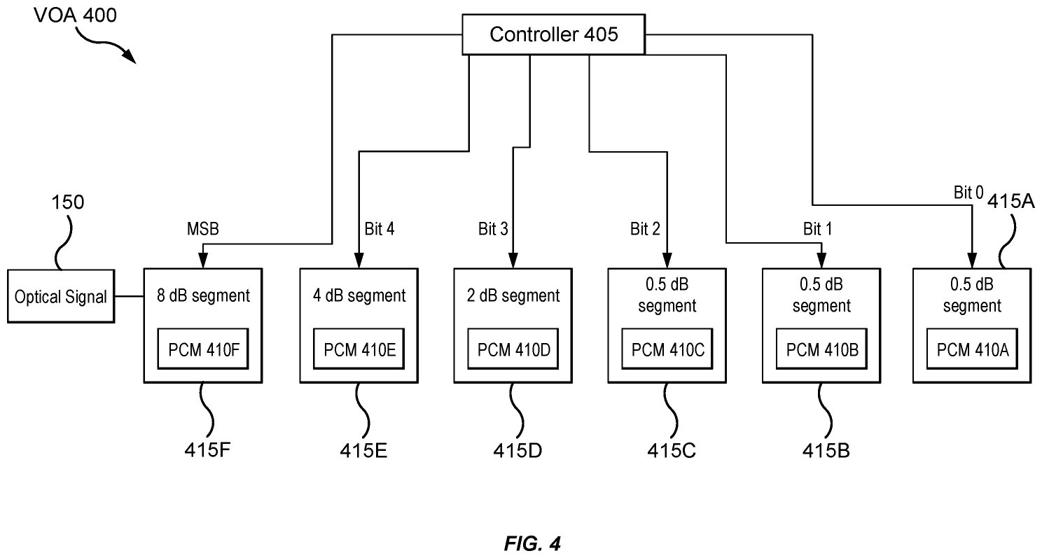

FIG. 4 is a block diagram of a VOA 400 with segments that provide different attenuation using PCM, according to one embodiment. The VOA 400 is a combination of a binary VOA and a thermometric VOA since the attenuation provided by each segment doubles relative to the previous segment for segments 415D-415F but segments 415A-415C provide the same attenuation. That is, the segments 415A-415C provide a 0.5 dB attenuation when the PCM 410A-410C is in an attenuation state (e.g., a crystalline state), which make up the thermometric part of the VOA 400. That is, the segments 415A-415C each provides a smallest amount of binary optical attenuation. In contrast, the segment 415D has PCM 410D that provides a 2 dB attenuation on the optical signal 150. The next segment 415E has PCM 410E that provides a 4 dB attenuation on the optical signal 150, and the next segment 415F has PCM 410F that provides an 8 dB attenuation on the optical signal 150. This is achieved by altering the size, shape, thickness, and/or type of the PCM 410 in the segments 415. For example, the PCM 410A-410C in the segments 415A-415C can be the same size and shape, while the PCM 410D-410F in the segments 415D-415F have different sizes, shapes, heights, and/or materials.

The VOA 400 also includes a controller 405 that provides a control signal that sets the state of the PCM 410 in the segments 415. The controller 405 can be circuitry disposed on the same photonic chip or IC as the VOA 400, or may be an external controller disposed on a different IC. The controller 405 can include a processor (or processing element) and memory. The controller 405 can be hardware, firmware, software, or combinations thereof.

In this example, the control signal includes six bits for controlling the state of the PCM 410 in the segments 415A-415F. That is, the least significant bit (LSB) controls the state of the PCM 210A in the segment 215A, Bit 1 controls the state of the PCM 210B in the segment 215B, Bit 2 controls the state of the PCM 210C in the segment 215C and so forth. As discussed above, controlling the bits in the control signal 220 can vary the overall (or total) attenuation the VOA 200 generates on the optical signal 150.

Like the controller 205 in FIG. 2, the controller 405 can control the segments 415 so that multiple segments attenuate the optical signal 150, or only one, or none of the segments attenuate the optical signal. If multiple segments 415 are in the attenuation state, the overall attenuation of the optical signal 150 is the combination (or sum) of the attenuation provided by each segment 415 that has PCM 210 in the attenuation state.

One advantage of the VOA 400 being a combination of a binary and thermometric VOA is that it may reduce switching power. For example, referring to the VOA 200 in FIG. 2, assume the VOA 200 is currently configured to provide a 3 dB attenuation where the PCM 210C in the segment 215C and the PCM 210B in the segments 215B are in the attenuation state. However, it is common in VOA applications for the controller to make a 0.5 dB adjustment. In this case, to go from 3 dB to 2.5 dB, the controller 205 has to switch the PCM 210B to the transmission state and switch the PCM 210A in the segment 215A to the attenuation state. In other words, the VOA 200 has to use power to switch two segments to make a 0.5 dB adjustment from 3 dB of total attenuation to 2.5 dB of total attenuation.

In contrast, when the VOA 400 provides a 3 dB attenuation, the PCM 410B-410D in the segments 415B-415D are in the attenuation state. To go to a 2.5 dB of attenuation, the controller 405 need only switch the PCM in either of the segments 415C or 415B to the transmission state. That is, unlike the VOA 200, the VOA 400 only has to switch one of the segments 415 rather than two. This can reduce the amount of power consumed by the VOA 400. Advantageously, the VOA 400 can offer better monotonicity and enable control during mission mode without any glitches. Further, although the VOA 400 may use more area than the VOA 200, this overhead is minimal due to compact size of the segments 415 as described above.

Thus, the VOA 400 can also be categorized as a 15.5 dB VOA which can attenuate an optical signal from 0 dB to 15.5 dB with a step size of 0.5 dB. That is, by setting the bits in the control signal 220, the controller can set the attenuation of the VOA 200 to 0.5 dB, 1 dB, 1.5 dB, 2 dB, 2.5 dB, 3 dB, 3.5 dB, etc. until reaching the maximum attenuation of 15.5 dB. The VOA 400 includes 3 binary bits and 3 thermometric bits.

Of course, VOA 400 is just one example of a combination of a binary and thermometric VOA. More binary and thermometric segments could be added or removed.

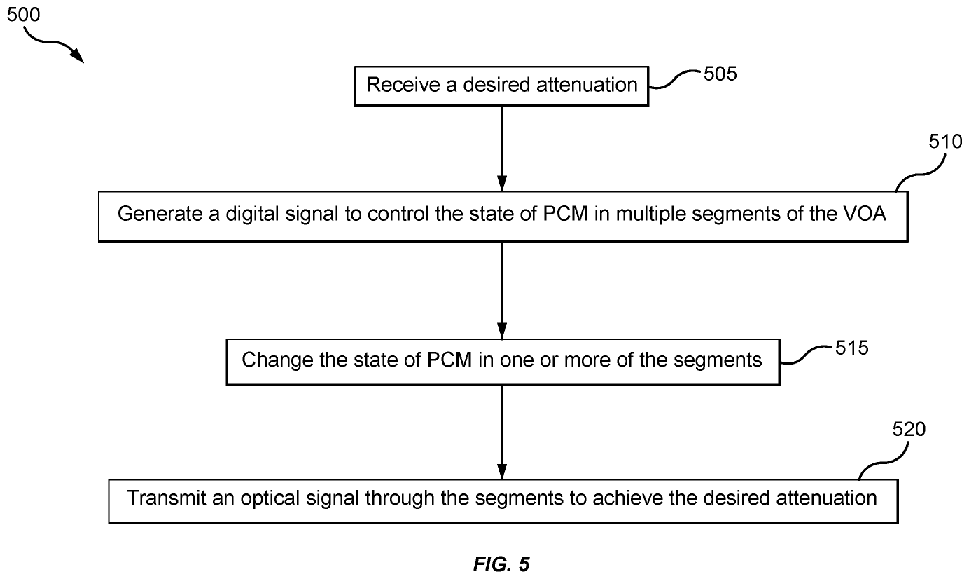

FIG. 5 is a flowchart of a method 500 for operating a VOA with phase change material, according to one embodiment. At block 505, the VOA (or a controller in the VOA) receives a desired attenuation of an optical signal.

At block 510, the controller generates a digital signal to control the state of PCM in multiple segments of the VOA. For example, the digital signal may indicate the state of the PCM in each segment. Alternatively, the digital signal may indicate which of segments should switch their PCM and which should keep their PCM in the current state.

At block 515, the VOA changes the state of PCM in one or more of the segments. Doing so changes the overall attenuation of the VOA on the received optical signal.

At block 520, the VOA transmits the optical signal through the segments to achieve the desired attenuation. For example, the VOA could have the PCM in all the segments in the attenuation state, only some of the segments in the attenuation state, or none of the segments in the attenuation state, in which case the optical signal is not attenuated when passing through the VOA.

In the current disclosure, reference is made to various embodiments. However, the scope of the present disclosure is not limited to specific described embodiments. Instead, any combination of the described features and elements, whether related to different embodiments or not, is contemplated to implement and practice contemplated embodiments. Additionally, when elements of the embodiments are described in the form of “at least one of A and B,” or “at least one of A or B,” it will be understood that embodiments including element A exclusively, including element B exclusively, and including element A and B are each contemplated. Furthermore, although some embodiments disclosed herein may achieve advantages over other possible solutions or over the prior art, whether or not a particular advantage is achieved by a given embodiment is not limiting of the scope of the present disclosure. Thus, the aspects, features, embodiments and advantages disclosed herein are merely illustrative and are not considered elements or limitations of the appended claims except where explicitly recited in a claim(s). Likewise, reference to “the invention” shall not be construed as a generalization of any inventive subject matter disclosed herein and shall not be considered to be an element or limitation of the appended claims except where explicitly recited in a claim(s).

As will be appreciated by one skilled in the art, the embodiments disclosed herein may be embodied as a system, method or computer program product. Accordingly, embodiments may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, embodiments may take the form of a computer program product embodied in one or more computer readable medium(s) having computer readable program code embodied thereon.

Program code embodied on a computer readable medium may be transmitted using any appropriate medium, including but not limited to wireless, wireline, optical fiber cable, RF, etc., or any suitable combination of the foregoing.

Computer program code for carrying out operations for embodiments of the present disclosure may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present disclosure are described herein with reference to flowchart illustrations and/or block diagrams of methods, apparatuses (systems), and computer program products according to embodiments presented in this disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the block(s) of the flowchart illustrations and/or block diagrams.

These computer program instructions may also be stored in a computer readable medium that can direct a computer, other programmable data processing apparatus, or other device to function in a particular manner, such that the instructions stored in the computer readable medium produce an article of manufacture including instructions which implement the function/act specified in the block(s) of the flowchart illustrations and/or block diagrams.

The computer program instructions may also be loaded onto a computer, other programmable data processing apparatus, or other device to cause a series of operational steps to be performed on the computer, other programmable apparatus or other device to produce a computer implemented process such that the instructions which execute on the computer, other programmable data processing apparatus, or other device provide processes for implementing the functions/acts specified in the block(s) of the flowchart illustrations and/or block diagrams.

The flowchart illustrations and block diagrams in the Figures illustrate the architecture, functionality, and operation of possible implementations of systems, methods, and computer program products according to various embodiments. In this regard, each block in the flowchart illustrations or block diagrams may represent a module, segment, or portion of code, which comprises one or more executable instructions for implementing the specified logical function(s). It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustrations, and combinations of blocks in the block diagrams and/or flowchart illustrations, can be implemented by special purpose hardware-based systems that perform the specified functions or acts, or combinations of special purpose hardware and computer instructions.

In view of the foregoing, the scope of the present disclosure is determined by the claims that follow.

We claim:

1. A variable optical attenuator (VOA), comprising:
an optical waveguide;
phase change material (PCM) disposed on the optical waveguide; and
electrodes configured to change a state of the PCM in order to change an attenuation of optical power in the optical waveguide.

2. The VOA of claim 1, wherein the optical waveguide comprises:
a first segment comprising a first portion of the PCM, wherein the first segment provides a first attenuation of an optical signal depending on a state of the first portion of the PCM; and
a second segment comprising a second portion of the PCM, wherein the second segment provides a second attenuation of the optical signal depending on a state of the second portion of the PCM.

3. The VOA of claim 2, further comprising:
a first pair of electrodes to control the state of the first portion of the PCM; and
a second pair of electrodes to control the state of the second portion of the PCM.

4. The VOA of claim 3, wherein the first pair of electrodes are doped with opposite type dopants, and the second pair of electrodes are doped with opposite type dopants.

5. The VOA of claim 3, wherein a voltage between the first pair of electrodes is controlled by a first bit in a digital control signal and a voltage between the second pair of electrodes is controlled by a second bit in the digital control signal.

6. The VOA of claim 1, wherein the electrodes consume power only when changing the state of the PCM.

7. The VOA of claim 1, wherein the VOA does not require calibration.

8. The VOA of claim 1, wherein the PCM comprises at least one of: germanium-antimony-tellurium or Germanium-antimony-selenium-tellurium.

9. The VOA of claim 1, wherein the optical waveguide comprises a plurality of segments each comprising a portion of the PCM, wherein the plurality of segments provide a different amount of binary optical attenuation.

10. The VOA of claim 9, wherein each of the portions of the PCM have different dimensions from each other.

11. The VOA of claim 9, wherein the optical waveguide comprises at least one other segment that provides the same optical attenuation as a segment in the plurality of segments that provides a smallest amount of binary optical attenuation.

12. A variable optical attenuator (VOA), comprising:
an optical waveguide; and
a plurality of segments comprising material that is configured to switch between an attenuation state and a transmission state to change an attenuation of optical power in the optical waveguide, wherein the VOA does not consume power in order to maintain the material in the attenuation state or the transmission state.

13. The VOA of claim 12, wherein the material is a phase change material (PCM).

14. A method, comprising:
receiving a desired attenuation for a variable optical attenuator (VOA) comprising phase change material (PCM) that changes an attenuation of optical power in an optical waveguide depending on a state of the PCM;
changing the state of the PCM based on the desired attenuation; and
transmitting an optical signal through the optical waveguide to achieve the desired attenuation.

15. The method of claim 14, wherein the optical waveguide comprises:
a first segment comprising a first portion of the PCM, wherein the first segment provides a first attenuation of the optical signal depending on a state of the first portion of the PCM; and
a second segment comprising a second portion of the PCM, wherein the second segment provides a second attenuation of the optical signal depending on a state of the second portion of the PCM.

16. The method of claim 15, further comprising:
a first pair of electrodes to control the state of the first portion of the PCM; and
a second pair of electrodes to control the state of the second portion of the PCM.

17. The method of claim 16, wherein a voltage between the first pair of electrodes is controlled by a first bit in a digital signal and a voltage between the second pair of electrodes is controlled by a second bit in the digital signal.

18. The method of claim 14, wherein the VOA consumes power only when changing the state of the PCM.

19. The method of claim 14, wherein the VOA does not require calibration.

20. The method of claim 14, wherein the optical waveguide comprises a plurality of segments each comprising a portion of the PCM, wherein the plurality of segments provide a different amount of binary optical attenuation.
